(19) United States
(12) Patent Application Publication
(10) Pub. No.: US 2025/0297697 A1
(43) Pub. Date: Sep. 25, 2025

(54) FLUID TRANSPORT TUBE

(71) Applicants: DENSO AIR SYSTEMS CORPORATION, Anjo-shi (JP); DENSO CORPORATION, Kariya-city (JP); GOMUNOINAKI CO., LTD., Nagoya (JP)

(72) Inventors: Hironao TANAKA, Anjo-shi (JP); Yosuke MIKAZUKI, Nagoya-shi (JP); Haruhisa SHIBATA, Kariya-city (JP); Shinichi OKAMOTO, Kariya-city (JP); Daiken IWAKAWA, Anjo-shi (JP); Hiroya NISHIMURA, Nagoya-shi (JP)

(21) Appl. No.: 19/228,255

(22) Filed: Jun. 4, 2025

Related U.S. Application Data
(63) Continuation of application No. PCT/JP2023/042738, filed on Nov. 29, 2023.

(30) Foreign Application Priority Data
Dec. 5, 2022 (JP) 2022-194106

(51) Int. Cl. F16L 11/12; F16L 11/08; F16L 59/14

(52) U.S. Cl. CPC F16L 11/125; F16L 11/085; F16L 59/143

(57) ABSTRACT

There is provided a fluid transport tube in which plurality of layers are laminated on one another. The plurality of layers include an outer layer composed of a thermoplastic elastomer foam. The plurality of layers also include an inner layer composed of thermoplastic elastomer or thermoplastic resin. The outer layer and inner layer closely adhere with each other. Thermoplastic elastomer foam has a foaming factor of 2 times or more to 5.5 times or less. This makes it possible to improve the thermal insulation and manufacturing stability of the fluid transport tube.

### CROSS-REFERENCE TO RELATED APPLICATION

This application is based on and claims the benefit of priority from earlier Japanese Patent Application No. 2022-194106 filed on Dec. 5, 2022 the description of which is incorporated herein by reference.

### TECHNICAL FIELD

The present disclosure relates to fluid transport tubes for transporting fluids.

### RELATED ART

In the past, Patent Document 1 describes a heat-insulating hose with improved insulation properties in a hose for transporting fluids. The insulating hose disclosed by Patent Document 1 has an outer layer having a foamed material (hereinafter referred to as “foamed layer”), a reinforcing layer, and an inner layer. The foamed layer, reinforcing layer, and inner layer are vulcanized and formed as a single member.

### CITATION LIST

### Patent Literature

[Patent Literature 1] JP-A-2005-188577

### SUMMARY OF THE INVENTION

In the insulating hose disclosed by the foregoing patent document 1, the inner layer is coated with the reinforcing layer and the foamed layer, and then the hose is molded into a desired shape. The foamed layer, reinforcing layer, and inner layer are then integrated by vulcanization.

However, when rubber is subjected to vulcanizing and foam molding, it is difficult to match the manufacturing conditions of both vulcanizing and foam molding in order to perform vulcanizing and foam molding simultaneously. For example, if priority is given to foam molding of the rubber, vulcanization molding of the rubber will be insufficient and strength will be insufficient. Conversely, if priority is given to vulcanization molding, the foaming agent may not foam sufficiently, or the foaming gas may escape from the foaming layer as the foaming progresses, resulting in low foaming. This makes it difficult to consistently produce insulating hose.

In view of the foregoing, the purpose of the present disclosure is to provide a fluid transport tube with excellent thermal insulation and manufacturing stability.

In order to realize the foregoing object, one mode of the present disclosure provides a fluid transport tube comprising multiple layers layered on one another, wherein,
the outer layer, of the multiple layers, is made of a thermoplastic elastomer foam,
the inner layer, of the multiple layers, is made of a thermoplastic elastomer or a thermoplastic resin,
the outer layer and the inner layer closely adhere with each other, and
the thermoplastic elastomer foam has a foaming factor of 2 times or more and 5.5 times or less.

According to this mode, it is possible to reduce the thermal conductivity of the outer layer and reduce the variations in thermal conductivity for each fluid transport tube during manufacturing thereof. Therefore, it is possible to improve the thermal insulation and manufacturing stability of the fluid transport tube.

In addition, another mode of the present disclosure provides a fluid transport tube comprising multiple layers layered on one another, wherein,
the outer layer, of the multiple layers, is made of a thermoplastic elastomer foam,
the inner layer, of the multiple layers, is made of a thermoplastic elastomer or a thermoplastic resin,
a reinforcing layer is arranged between the outer layer and the inner layer, the reinforcing layer adhering closely with each of the outer layer and the inner layer, and
the thermoplastic elastomer foam has a foaming factor of 2 times or more and 5.5 times or less.

According to this mode, it is possible to reduce the thermal conductivity of the outer layer and reduce the variations in thermal conductivity for each fluid transport tube during manufacturing thereof. Therefore, it is possible to improve the thermal insulation and manufacturing stability of the fluid transport tube.

### BRIEF DESCRIPTION OF THE DRAWINGS

FIG. 1 is a cross-sectional view showing a fluid transport tube according to a first embodiment.

FIG. 2 is an explanatory diagram explaining the manufacturing method of the fluid transport tube.

FIG. 3 is a characteristic diagram showing a relationship between foaming factors and thermal conductivities of olefin-based foam tubes.

FIG. 4 is a characteristic diagram showing a relationship between foaming factors and variations in thermal conductivities of olefin-based foam tubes.

FIG. 5 is a characteristic diagram showing a relationship between foaming factors and thermal conductivities of styrene-based foam tubes.

FIG. 6 is a characteristic diagram showing a relationship between foaming factors and variations in thermal conductivities of styrene-based foam tubes.

FIG. 7 is a microscope image showing a cross section of the outer layer in the first embodiment.

FIG. 8 is a cross section showing a fluid transport tube according to a second embodiment.

FIG. 9 is a cross section showing a fluid transport tube according to a third embodiment.

### DESCRIPTION OF EMBODIMENTS

The following is a description of multiple embodiments for implementing the present disclosure, with reference to the drawings. In the respective embodiments, elements of portions corresponding to those described in the preceding embodiment(s) may be marked with the same reference numbers and duplicate explanation may be omitted. When only a part of the configuration is described in each embodiment, the configurations corresponding to the ones described in the preceding embodiment(s) may be applied to the configurations other than that part of the configurations in each embodiment. Not only combinations of parts that are specifically indicated as combinable in each embodiment, but also partial combinations of embodiments without being explicitly indicated are possible if no particular obstacle to such a combination arises in the combination.

### First Embodiment

Hereinafter, a first embodiment will now be described with reference to the accompanying drawings.

In the first embodiment, the fluid transport tube is used as a hot water transport tube for transporting hot water used as a heat source for heating in an electric vehicle air conditioning system. The hot water may be an antifreeze liquid (LLC) or water. As the antifreeze liquid, for example, a glycol-based antifreeze liquid may be used.

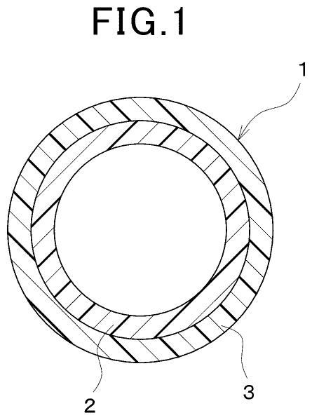

As shown in FIG. 1, the fluid transport tube 1 according to the present embodiment is composed of multiple layers. The multiple layers include an inner layer 2 and an outer layer 3 which are layered in this order from the inside. An internal space is provided in the inner layer 2 through which warm water flows.

The inner layer 2 is made of a thermoplastic elastomer or a thermoplastic resin. As the inner layer 2, for example, an olefin-based thermoplastic elastomer, an olefin-based resin, a polyamide resin, a polyphenylene sulfide (PPS) resin, or a mixture of such resins can be used.

The outer layer 3 is made of thermoplastic elastomer foam. As the outer layer 3, for example, an olefin-based thermoplastic elastomer foam, a styrene-based thermoplastic elastomer foam, or a urethane-based thermoplastic elastomer foam can be used. More specifically, the outer layer 3 can be foamed by foaming an olefin-based thermoplastic elastomer, a styrene-based thermoplastic elastomer, or a urethane-based thermoplastic elastomer using heat-expandable microcapsules. Additionally, a skin layer (not shown) may be provided on the outer side of the outer layer 3.

The inner layer 2 and outer layer 3 closely adhere to each other. In this specification, “closely adhere (or deeply adhere)” refers not only to a state in which the resin portion or elastomer portion of the outer layer 3 is in contact with the inner layer 2, but also includes the following state. That is, the definition of “close (or deep) adherence” also includes a state in which bubbles are uniformly foamed in the foam of the outer layer 3 and the bubble portion of the outer layer 3 is partially in contact with the inner layer 2.

The thermal elastomer is a polymer material composed of a mixture of a hard segment, which is a resin component, and a soft segment, which is composed of a resin component or a rubber component. By changing the mixing ratio of the hard and soft segments, the hardness of the thermoplastic elastomer can be adjusted.

For example, when applying the fluid transport tube 1 to piping installed in a vehicle engine compartment, the mixing ratio of the soft segment of the thermoplastic elastomer is increased. This mixing ratio adjustment increases the flexibility of the fluid transport tube 1 and improves its maneuverability.

Meanwhile, when applying the fluid transport tube 1 to piping installed under the floor of a vehicle, the mixing ratio of the hard segment of the thermoplastic elastomer is increased. This adjustment increases the rigidity of the fluid transport tube 1, resulting in a reduction of the number of fastening points to the vehicle body.

The olefin-based thermoplastic elastomer is composed of a mixture of the hard segment, such as PP (polypropylene) or PE (polyethylene), and the soft segment, such as EPDM (ethylene propylene diene rubber) or EPM (ethylene propylene rubber).

The styrene-based thermoplastic elastomer is provided to include, as the hard segment, PS (polystyrene), and, as the soft segment, PE (polyethylene) or PB (polybutadiene) or polyethylene-polybutylene. As the styrene-based thermoplastic elastomer, for example, SEBS (styrene-ethylene-butylene-styrene block copolymer) can be adopted.

In the present embodiment, the fluid transport tube 1 is formed by co-extrusion molding, which simultaneously extrudes the material of the inner layer 2 (hereinafter referred to as the inner layer material) and the material of the outer layer 3 (hereinafter referred to as the outer layer material). Specifically, the inner layer material and the outer layer material are co-extruded through a die provided at the tip of a co-extrusion machine, thereby forming the fluid transport tube 1, which is a laminate of the inner layer 2 and the outer layer 3.

When performing co-extrusion, the desired die temperature and extrusion speed are set as manufacturing conditions for the co-extrusion machine. As a result, extrusion pressure is applied from the outer layer material containing the foam to the inner layer material at the die. In other words, the outer layer material containing the foam (before foaming) is forced to partially penetrate into the inner layer material. Subsequently, as the extrusion begins, the diameter (inner diameter, outer diameter) of each of the bubbles (the heat-expandable microcapsules) in the foam gradually increases, and a two-layer structured fluid transport tube 1 is formed, wherein the inner layer 2 is completely covered by the outer layer 3 in its entire circumferential and length-wise directions of the tube 1.

As a result, in the formed tube 1, the inner surface of the outer layer 3 partially penetrates into the outer surface of the inner layer 2 due to the foregoing extrusion pressure. Furthermore, the partially intruded portions are reinforced by the expanded foam bubbles. The outer layer 3 and the inner layer 2 adhere tightly with each other in the foregoing “closely adhered” state. In this closely adhered state, the areas being bonded between the outer layer 3 and the inner layer 2, which areas are provided by the resins themselves of the outer and inner layers 3 and 2, are increased with a decrease in the forming factor of the bubbles. The smaller the foaming factor of the bubbles, the larger the areas being bonded. Hence, properly adjusting the foaming factor provides properly adjusted and larger bonding areas between the layers, thereby providing a controlled higher adhesive (bonding) strength between the layers.

According to this manufacturing method, the inner layer 2 and outer layer 3 can be formed simultaneously, thereby improving the adhesive (bonding) strength required between inner layer 2 and outer layer 3. Furthermore, the manufacturing time for fluid transport tube 1 can be shortened.

The fluid transport tube 1 according to the present embodiment may be formed by methods other than the co-extrusion method. For example, the fluid transport tube 1 may be formed by single-layer extrusion molding performed with a batch process or a continuous process, which is as described below.

In the single-layer extrusion molding using a batch process, first of all, inner layer material is fed into the hopper of the extruder, and the inner layer 2 is first extruded in a tube shape to form an inner layer tube as a single member. Outer layer material is then fed into the hopper, and the outer layer 3 is coated onto the inner layer tube while pulling out the inner layer tube. These processes form a fluid transport tube 1, which is a laminate of the inner layer 2 and the outer layer 3.

According to this manufacturing method, the inner layer 2 and outer layer 3 can be manufactured under arbitrary temperature and flow conditions. Therefore, the optimum manufacturing conditions for the dimensions and degree of foaming of the fluid transport tube 1 can be easily adjusted. In addition, since the inner layer 2 and outer layer 3 are manufactured sequentially in a single extruder, there is no need to increase the number of extruders, and the production can be done on a minimal scale.

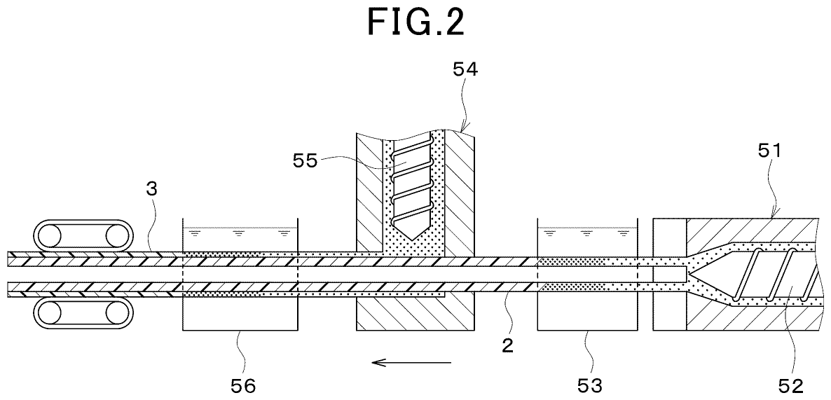

In the single-layer extrusion molding with the continuous process, two extruders are prepared to produce a fluid transport tube 1 in the continuous process. Specifically, as shown in FIG. 2, the inner layer material is first fed into the hopper (not shown) of the first extruder 51, extruded by the first cylinder 52 to form the inner layer 2, which is then made to pass through a first water tank 53 to stabilize the dimensions. The inner layer 2 is then coated with the outer layer material by the second cylinder 55 of the second extruder 54, and the inner layer 2 and outer layer 3 are cooled again in the second water tank 56. Thus, such processes produce the fluid transport tube 1, which is a laminate composed of the inner layer 2 and outer layer 3.

Since the two extruders are used in this manufacturing method, compared to the batch process, there is no need to replace the extruded materials during the manufacturing process, so that the manufacturing time can be shortened. Also, compared to co-extrusion molding, in which the inner layer 2 is cooled through the outer layer 3, the inner layer 2 and outer layer 3 can be cooled in a shorter time.

Even in the foregoing single-layer extrusion molding performed with a batch process or a continuous process, the foregoing close adherence between the outer layer 3 and the inner layer 2 can be gained, although there are differences in degree.

The inventors of the present application investigated the foaming factor of the outer layer 3 of the fluid transport tube 1. First, the foaming factor of the outer layer 3 was examined in a case where the olefin-based thermoplastic elastomer foam was employed as the outer layer 3.

First, the inventors extruded several kinds of olefin-based foam tubes with different foaming factors and measured the thermal conductivity of each of the obtained olefin-based foam tubes. Specifically, LE-3170N produced by RIKEN TECHNOS CORPORATION was used as the olefin-based thermoplastic elastomer. P501E1 produced by Sekisui Chemical Co., Ltd., which functions as heat-expandable microcapsules, was mixed with this elastomer in 3, 5, 8, 10, 15, and 25 weight parts, thus preparing six different mixtures.

Each of these six mixtures was extruded by a general-purpose resin extruder manufactured by IKG cooperation to produce olefin-based foam tubes with an inner diameter of φ16 and an outer diameter of φ20. Extrusion conditions were as follows: cylinder and die temperature of the extruder: 170 to 220° C., extrusion flow rate: 0.01 to 0.04 kg/s. The olefin-based foam tubes were measured by a specific gravity meter, which exhibit the foaming factor of 1.4 to 5.7 times.

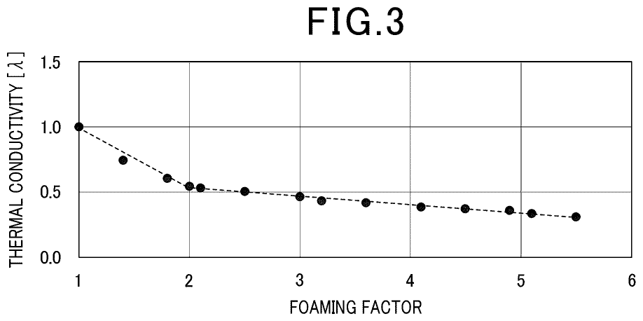

The thermal conductivity of each of the produced olefin-based foam tubes was then measured. First, each of the olefin-based foam tubes was covered on an aluminum pipe of a diameter of 17 mm, and a heat flow sensor (model D0001TC) produced by DENSO Corporation and a polyimide tape were attached on each of the tubes. The thermal conductivity was calculated by circulating 80° C. hot water through the aluminum pipe at a flow rate of 5 L/min. using a chiller produced by Apiste Corporation, during which the heat flow (unit: W) through each of the olefin-based foam tubes measured. The results are shown in FIG. 3.

The lateral axis of the graph shown in FIG. 3 denotes the foaming factor of olefin-based foam tubes, while the vertical axis of the graph shown in FIG. 3 denotes the thermal conductivity index. The thermal conductivity index is defined as a thermal conductivity expressed as having a foaming factor of 1 provided when the tube with no foaming agent gives a foaming factor 1.

When the calculated thermal conductivities of the olefin-based foam tubes are sorted by foaming factor, there are data showing multiple thermal conductivities for each foaming factor. In other words, there are variations in thermal conductivity for each foaming factor. The thermal conductivity on the vertical axis of the graph shown in FIG. 3 shows the average of multiple calculated values.

FIG. 3 clearly shows that the thermal conductivity of olefin-based foam tubes decreases rapidly with an increase in the foaming factor between 1 and 2 times (exclusive) of the foaming factor. When the foaming factor of olefin-based foam tube is 2 times or more, the degree of decrease in thermal conductivity becomes smaller provided when the foaming factor is increased. Therefore, if the foaming factor of the olefin-based foam tubes is 2 times or more, lower thermal conductivity, i.e., higher thermal insulation, can be ensured.

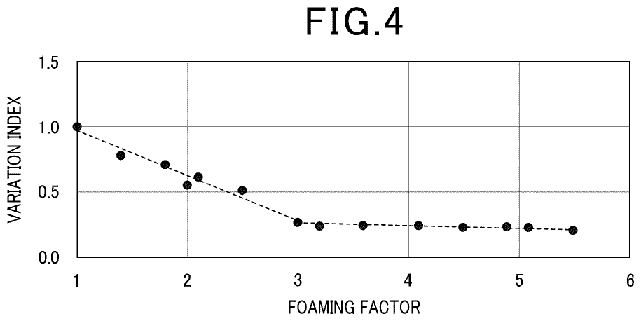

A range of variations of thermal conductivity with respect to the foaming factor was then calculated for the foregoing olefin-based foam tubes. The results are shown in FIG. 4.

The lateral axis of the graph shown in FIG. 4 shows the foaming factor of the olefin-based foam tubes, while the vertical axis of the graph shown in FIG. 4 shows the variation index of thermal conductivity. The variation index of thermal conductivity is defined, as an index, as a range of variations in thermal conductivity provided on condition that a range of variations in the thermal conductivity is given as 1 when the tube contains no foaming agent, i.e., when the foaming factor is 1 (hereinafter referred to as the initial state). The variation range of the thermal conductivity is defined as a difference between the maximum value and minimum value of the thermal conductivity. For example, if the variation range of the thermal conductivities for a certain foaming factor is half of the variation range of the thermal conductivities in the initial state, the variation index of thermal conductivity is expressed as 0.5.

It is clear from FIG. 4 that as the foaming factor of the olefin-based foam tubes increases, the variation range of the thermal conductivities decreases. This decrease can be attributed to the following reasons.

In other words, thermoplastic elastomers which are composed of multiple components with different thermal conductivities have a large range of thermal conductivity variations due to material heterogeneity. With an increase in the foaming factor, the components of the thermoplastic elastomer can be replaced by i) hydrocarbon gases encapsulated in heat-expandable microcapsules, ii) hydrocarbon gases released when the heat-expandable microcapsules burst during production, iii) air resulting from defects during manufacturing, or, iv) a mixture of those hydrocarbon gases and air. Hydrocarbon gases or the gas mixture have a smaller variation in thermal conductivity. Hence, as the foaming factor increases, the variation range of thermal conductivities of the foam tubes is expected to decrease.

In addition, when the foaming factor is small, uneven mixing of heat-expandable microcapsules is likely to occur in addition to variations in the thermal conductivity due to inhomogeneity of the thermoplastic elastomer material. When the heat-expandable microcapsules are foamed in this state, the distribution of bubbles in the foam tube is likely to be uneven, and the range of variations in thermal conductivity is unlikely to be smaller.

As shown in FIG. 4, the variation range of thermal conductivity decreases rapidly as the foaming factor of olefin-based foam tubes increases from 1 to 3 times. When the foaming factor of olefin-based foam tubes becomes larger than 3 times, the variation range of thermal conductivities hardly changes even when the foaming factor is increased. Therefore, if the foaming factor of olefin-based foam tubes is larger than 3 times, a smaller variation in thermal conductivities can be ensured. As a result, the manufacturing stability of foam tubes can be ensured.

The olefin-based foam tubes were then evaluated for cracking resistance obtained when being bent. Specifically, the olefin-based foam tubes were placed along the R120 jig at a 90° angle, manually angle-adjusted, and whether cracks or splits appeared on the foam tubes was visually checked. As a result, no cracking occurred when the foaming factor is 5.5 times or less, whilst cracking occurred when the foaming factor is 5.7 times. Hence, it was confirmed that cracking of olefin-based foam tubes can be suppressed by setting the foaming factor to 5.5 times or less.

The inventors then investigated the foaming factor of the outer layer 3 when the styrene-based thermoplastic elastomer foam was used as the outer layer 3.

First, the inventors extruded several types of styrene-based foam tubes with different foaming factors, and measured the thermal conductivity of each of the resulting styrene-based foam tubes. Specifically, T-A80NT (produced by ARONKASEI Co., Ltd.) as a styrene-based thermoplastic elastomer was used instead of LE-3170N for the foregoing olefin-based foam tube production conditions, except that T-A80NT was used instead of LE-3170N. The foaming factors of the thus-produced styrene-based foam tubes were 1.2 to 4.8 times.

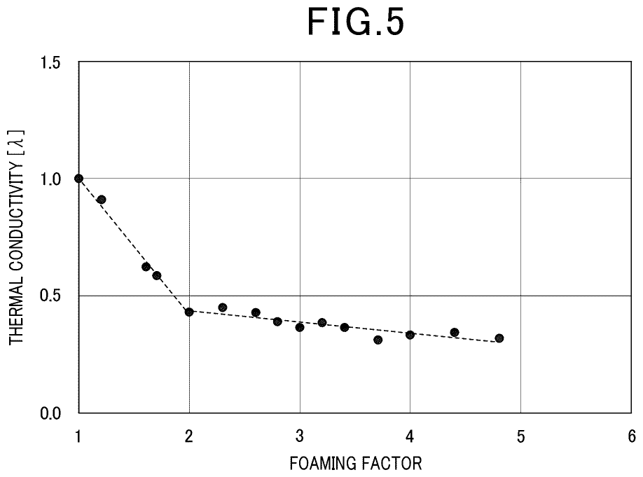

The thermal conductivity of each of the foregoing styrene-based foam tubes was then measured. The same measurement conditions were used as those used for the thermal conductivity measurement of the olefin-based foam tubes, described before. The results are shown in FIG. 5.

FIG. 5 shows that the thermal conductivities of the styrene-based foam tubes decrease rapidly as the foaming factor is increased from 1 to 2 times (exclusive). When the foaming factor of the styrene-based foam tubes is 2 times or more, the degree of a decrease in the thermal conductivities obtained when the foaming factor is increased becomes smaller. As a result, if the foaming factor of the styrene-based foam tubes is 2 times or more, lower thermal conductivity, i.e., higher thermal insulation, can be ensured.

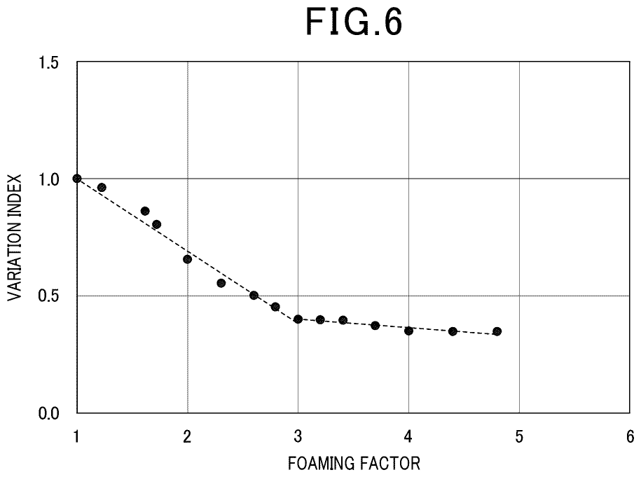

The range of variations in the thermal conductivity with respect to the foaming factor was then calculated for the foregoing styrene-based foam tubes. The results are shown in FIG. 6.

As shown in FIG. 6, the range of variations in the thermal conductivities with respect to the foaming factors was similar for the styrene-based foam tubes to the olefin-based foam tubes described before. Accordingly, if the foaming factor of the styrene-based foam tubes is larger than 3 times, it is possible to ensure smaller variations in the thermal conductivity. The manufacturing stability of foam tubes thus can be ensured.

The cracking resistance of the foregoing styrene-based foam tubes under bending was then evaluated. The same evaluation conditions were used as those used for the foregoing olefin-based foam tubes. As a result, no cracking occurred at a foaming factor of 4.8 or less. Hence, it was found that cracking of the styrene-based foam tubes can be reduced or prevented by setting the foaming factor to 4.8 times or less.

The following examples are provided to explain the present disclosure in more detail. Incidentally, the following disclosure will not be limited to only the following examples.

### EXAMPLE 1

As the inner layer material, GA-1190N produced by RIKEN TECHNOS CORPORATION, which is an olefin-based thermoplastic elastomer, was prepared. As the outer layer material, LE-3170N, an olefin-based thermoplastic elastomer produced by RIKEN TECHNOS CORPORATION was prepared. This LE-3170N was mixed with P501E1 which is an agent composed of heat-expandable microcapsules produced by Sekisui Chemical Company Lid., such that the P501E1 is 5 parts by weight. Thus, a mixture of the olefin-based thermoplastic elastomer with the heat-expandable microcapsules was prepared.

Next, the inner layer material and outer layer material were co-extruded using a co-extruder (produced by I.K.G. Co., Ltd.) to produce a fluid transport tube 1 with an inner diameter of φ16 and an outer diameter of φ24. The extrusion molding conditions were set so that the inner layer 2 had an inner diameter of φ16 and an outer diameter of φ20, and the outer layer 3 had an inner diameter of φ20 and an outer diameter of φ24. Additionally, the cylinder and die temperatures of the co-extruder were set to 170-220° C., and the extrusion flow rate was set to 0.01-0.04 kg/sec. When the outer layer 3 of the manufactured fluid transport tube 1 was measured using a density meter, the foaming factor was found to be 2.1 times.

### EXAMPLE 2

As the inner layer material, the same material as that shown in example 1 was prepared. As the outer layer material, LE-3170N, which is an olefin-based thermoplastic elastomer produced by RIKEN TECHNOS Corporation, was prepared. This LE-3170N was mixed with P501E1 which is an agent composed of heat-expandable microcapsules produced by Sekisui Chemical Co., Ltd., such that the P501E1 is 10 parts by weight. Thus a mixture of the olefin-based thermoplastic elastomer with the heat-expandable microcapsules was prepared.

The inner layer material and outer layer material were co-extruded under the same conditions as those shown in Example 1 to produce a fluid transport tube 1. The foaming factor of the outer layer 3 of the manufactured fluid transport tube 1 was measured using a hydrometer, and found to be 3.2 times.

### EXAMPLE 3

As the inner layer material, the same material as that shown in example 1 was prepared. Meanwhile, as the outer layer material, T-A80NT, which is a styrene-based thermoplastic elastomer produced by ARONKASEI Co., Ltd., was prepared. This T-A80NT was mixed with P501E1 which is heat-expandable microcapsules produced by Sekisui Chemical Co., Ltd. such that the P501E1 is 8 parts by weight. Thus a mixture of the styrene-based thermoplastic elastomer with the heat-expandable microcapsules was prepared.

The inner layer material and outer layer material were co-extruded under the same conditions as those shown in Example 1 to produce a fluid transport tube 1. The foaming factor of the outer layer 3 of the manufactured fluid transport tube 1 was measured using a hydrometer, and found to be 2 times.

### EXAMPLE 4

As the inner layer material, the same material as that shown in example 1 was prepared. Meanwhile, as the outer layer material, a mixture was prepared between T-A80NT, which is a styrene-based thermoplastic elastomer produced by ARONKASEI Co., Ltd., and P501E1, which is heat-expandable microcapsules produced by Sekisui Chemical Co., Ltd. In the mixture, the P501E1 was 15 parts by weight.

The inner layer material and outer layer material were co-extruded under the same conditions as those shown in Example 1 to produce a fluid transport tube 1. The foaming factor of the outer layer 3 of the manufactured fluid transport tube 1 was measured using a hydrometer, and found to be 3 times.

### Comparison Example

As a comparison example, a heater hose was prepared in which both the inner layer and the outer layer are made of ethylene propylene diene (EPDM) rubber. The heater hose has an inner diameter of φ16 and an outer diameter of φ24. In the heater hose, the inner layer has an inner diameter of φ16 and an outer diameter of φ20, while the outer layer has an inner diameter of φ20 and an outer diameter of φ24. Between the inner layer and the outer layer, there is a reinforcing layer reinforced by polyamide-based reinforcing yarns that are braided together.

### Flexibility Test

The fluid transport tubes produced in examples 1 to 4 (hereinafter, also referred to as “tube 1”) and the heater hose produced in the comparison example were cut to a length of 300 mm. The cut ends of the tube or hose were held and aligned by hand at an angle of 90° to the R120 jig. In this state, any abnormalities such as kinks (i.e., bends), cracks, or fractures were visually inspected.

### Heat Dissipation Measurement

The tubes 1 produced in examples 1 to 4 and the heater hose produced in the comparison example were each covered with an aluminum pipe with an outer diameter of φ17, and a heat flow sensor (model D0001TC), produced by DENSO Corporation, and a polyimide tape were attached to the pipe surface. Then, 80° C. hot water was circulated at a flow rate of 5 L/min using a chiller produced by Apiste Corporation, and the heat flux (unit: W) was measured. From these measurement results, heat dissipation (unit: W/m) was calculated.

### Pressure Resistance Test

The tubes 1 to 4 produced in examples 1 to 4 and the heater hose produced in the comparison example were inserted into aluminum pipes with an outer diameter of φ17, respectively, and secure them using worm drive hose clips (model OX-SS) manufactured by Orbital fasteners Co. UK. Then, a pressure of 108 kPa is applied using the test machine. In this state, any abnormalities such as cracks or fractures were visually inspected.

### High-Temperature Storage Test

After inserting aluminum pipes with both ends sealed into the interior of tubes 1 to 4 in example 1 to 4 and the heater hose in the comparison example, they were fastened with warm drive hose clips (model OX-SS) manufactured by Orbital fasteners Co. UK. Next, a mixture of a Super Long Life Coolant (Model 08889-01005), produced by TOYOTA MOTOR CORPORATION, and purified water diluted in a 1:1 ratio was filled into Tube 1 and the heater hose, and the assembly was placed in a high-temperature test chamber at 100° C. and left for 168 hours. Afterward, the tube 1 and heater hose were removed, and any abnormalities such as cracks or breaks were visually inspected on the tube 1 and heater hose.

### Evaluation

The results of the above tests and measurements are shown in Table 1.

TABLE 1

| | COMPARISON | | | | |
|---|---|---|---|---|---|
| | EXAMPLE | EXAMPLE 1 | EXAMPLE 2 | EXAMPLE 3 | EXAMPLE 4 |
| SPECIFICATION | EPDM | GA-1190N | GA-1190N | GA-1190N | GA-1190N |
| INNER LAYER | EPDM | LE-3170N + | LE-3170N + | T-A80NT + | T-A80NT + |
| ϕ16/ϕ20 | | P501E1 | P501E1 | P501E1 | P501E1 |
| OUTER LAYER | | (FOAMING | (FOAMING | (FOAMING | (FOAMING |
| ϕ20/ϕ24 | | FACTOR: 2×) | FACTOR: 3×) | FACTOR: 2×) | FACTOR: 3×) |
| EVALUATION 1 | ◯ | ◯ | ◯ | ◯ | ◯ |
| FLEXIBILITY TEST | | | | | |
| EVALUATION 2 | 108 | 65 | 60 | 53 | 49 |
| HEAT DISSIPATION | | | | | |
| [W/m] | | | | | |
| EVALUATION 3 | ◯ | ◯ | ◯ | ◯ | ◯ |
| PRESSURE | | | | | |
| RESISTANCE TEST | | | | | |
| EVALUATION 4 | ◯ | ◯ | ◯ | ◯ | ◯ |
| HIGH TEMPERATURE | | | | | |
| REPORTING TEST | | | | | |

As shown in Table 1, no abnormalities such as cracks or fractures were observed in the flexibility test, pressure resistance test, and high-temperature storage test for both Tube 1 of Examples 1-4 and the heater hose of the comparison example. The results of the heat dissipation measurement indicated that the heat dissipation of Tube 1 in Examples 1-4 was lower than that of the heater hose in the comparison example. This indicates that the thermal insulation of tubes 1 in examples 1-4 is higher than that of the heater hose in the comparison example.

### Cross-Sectional Observation

Next, cross-sectional observation was performed on the outer layer 3 of fluid transport tube 1. As the outer layer material, the same olefin-based thermoplastic elastomer as in Example 1, LE-3170N produced by RIKEN TECHNOS Corporation, was used, heat-expandable microcapsules P501E1 produced by Sekisui Chemical Co., Ltd . . . were mixed. The foaming factor of outer layer 3 during extrusion molding was 3.8 times. At this time, the heat-expandable microcapsules had a particle size of 22-42 μm (average 28 μm) before foaming and 65-132 μm (average 92 μm) after foaming.

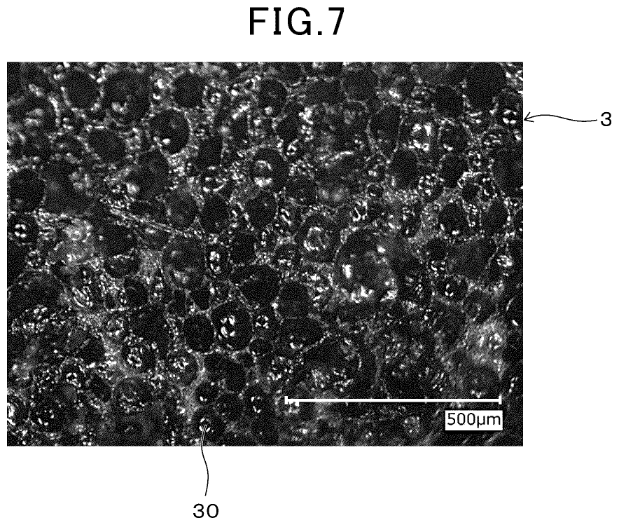

The outer layer 3 was cut, and the cut surface was observed under a microscope. The microscope photograph is shown in FIG. 7. As shown in FIG. 7, it was confirmed that bubbles 30 caused by heat-expandable microcapsules were uniformly distributed in the outer layer 3.

As described above, in the fluid transport tube 1 of the present embodiment, the foaming factor of the thermoplastic elastomer foam of the outer layer 3 is set to be two times or more and 5.5 times or less. This reduces the thermal conductivity of the outer layer 3 and reduces the variation in thermal conductivity between individual fluid transport tubes 1 during manufacturing. As a result, it is possible to improve the thermal insulation and manufacturing stability of the fluid transport tube 1.

Furthermore, by setting the foaming factor of the thermoplastic elastomer foam in outer layer 3 to be greater than 3 times and less than 5.5 times, the thermal conductivity of outer layer 3 can be reduced and the variation in thermal conductivity of each fluid transport tube 1 during manufacturing can be reduced more reliably. The thermal conductivity of each fluid transport tube 1 can be reduced more reliably by setting the foaming factor of the outer layer 3 to be greater than 3 times and less than 5.5 times. Therefore, the thermal insulation and manufacturing stability of fluid transport tube 1 can be improved more reliably.

In the present embodiment, the olefin-based Thermoplastic elastomer foam or styrene-based Thermoplastic elastomer is used as the outer layer 3. Moreover, the olefin-based Thermoplastic elastomer or olefin-based Thermoplastic resin is used as the inner layer 2.

In general, the olefin-based thermoplastic elastomer, olefin-based resin and styrene-based thermoplastic elastomer have excellent heat resistance, low temperature stability, and weather resistance. Therefore, by using the olefin-based thermoplastic elastomer, olefin-based resin and styrene-based thermoplastic elastomer as elements of the inner layer 2 and outer layer 3, the fluid transport tube 1 can be suitably installed and used in a vehicle. In addition, the olefin-based thermoplastic elastomer, olefin-based resin, and styrene-based thermoplastic elastomer are inexpensive materials, which can contribute to a reduce of manufacturing costs.

In the present embodiment, the inner layer 2 is made of a resin different from the thermoplastic elastomer contained in the outer layer 3. According to this structure, since the resin is harder than the thermoplastic elastomer, heat resistance and pressure resistance to the fluid flowing inside the inner layer 2, that is, the tube, can be secured even when the inner layer 2 is made thinner. The thinner the inner layer 2 is, the thicker the outer layer 3 can be. Accordingly, even if the fluid transport tube 1 has the same inner and outer diameters, thermal insulation can be improved.

In the fluid transport tube 1 according to the present embodiment, the outer layer 3 contains the heat-expandable microcapsules. The heat-expandable microcapsules have a high expansion factor and stable expandability. Hence, it is possible to reliably foam the outer layer 3 with a desired foaming factor.

### Second Embodiment

A second embodiment of the present disclosure will now be described with reference to the accompanying drawings. The second embodiment differs from the first embodiment in a configuration provided between the inner layer 2 and the outer layer 3.

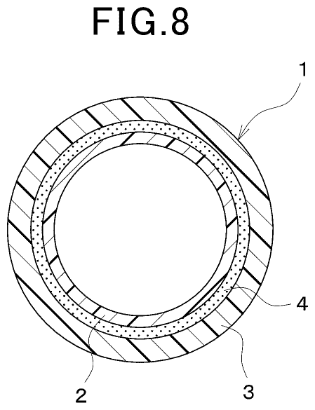

As shown in FIG. 8, a fluid transport tube 1 according to the second embodiment is composed of a hard resin or elastomer. In the fluid transport tube 1 of the present embodiment, a reinforcing layer 4 is provided between the outer layer 3 and the inner layer 2. This reinforcing layer 4 is directly contacted with each of the outer layer 3 and the inner layer 2.

The outer layer 3 and inner layer 2 can be made of the same material as those described in the first embodiment. The reinforcing layer 4 can be made of, for example, a polyamide resin, a polyphenylene sulfide resin, or a mixture thereof, or an adhesive such as maleic acid-modified polypropylene.

At least one of an interlayer provided between the inner layer 2 and the reinforcing layer 4 an interlayer provided between the outer layer 3 and the reinforcing layer 4, there may be provided with an adhesive such as maleic acid-modified polypropylene. This adhesive arrangement in the interlayer(s) improves the adhesive strength between the layers.

The configurations of elements other than the foregoing in the fluid transport tube 1 are the same as those of the first embodiment. Accordingly, the fluid transport tube 1 according to the second embodiment can also have the same effects as those of the first embodiment. In other words, the fluid transport tube 1 according to this embodiment makes it possible to improve thermal insulation and manufacturing stability.

Additionally to the foregoing, the fluid transport tube 1 according to the second embodiment is provided with the reinforcing layer 4 is inserted between the outer layer 3 and the inner layer 2. By providing the reinforcing layer 4, it is possible to improve the heat resistance and pressure strength of the fluid transport tube 1, resulting in that thermal deformation can be suppressed or reduced.

### Third Embodiment

A third embodiment according to the present disclosure will now be described with reference to the accompanying drawings. The third embodiment differs from the second embodiment in the configurations of the inner layer 2 and the reinforcing layer 4.

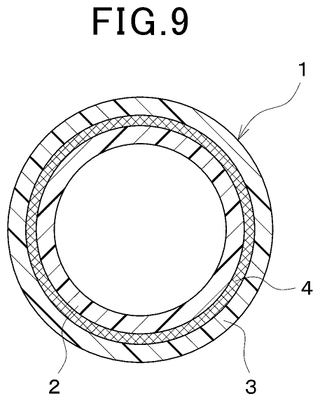

As shown in FIG. 9, the present embodiment provides a fluid transport tube 1 which is made of a flexible resin or elastomer. Specifically, the inner layer 2 is made of a highly flexible thermoplastic elastomer. For example, an olefin-based thermoplastic elastomer can be used as the inner layer 2, while the outer layer 3 can be made of the same material as that described in the first embodiment.

As the reinforcing layer 4, a known reinforcing layer may be used, which is formed by braiding a reinforcing thread in a spiral or a blade pattern. As the reinforcing thread, for example, a thread made of polyester, polyamide (nylon), polyvinyl alcohol (vinylon), rayon, aramid, polyethylene terephthalate (PET), polyethylene naphthalate (PEN), etc., can be used. The reinforcing thread may also be threads that have undergone an adhesive treatment. Examples of adhesive treatments include the use of a resorcinol-formaldehyde-rubber latex (RFL) treatment.

The configurations of elements other than the fluid transport tube 1 is the same as those employed by the first embodiment. Thus, the fluid transport tube 1 according to the third embodiment can also achieve the same effects as those gained in the first embodiment. In other words, the fluid transport tube 1 according to this embodiment makes it possible to improve thermal insulation and manufacturing stability.

In addition, in the fluid transport tube 1 according to the present embodiment, a thermoplastic elastomer having higher flexibility is used as the inner layer 2, and the reinforcing layer 4 is provided between the outer layer 3 and the inner layer 2. This configuration enhances flexibility thanks to adaptation of the inner layer 2 while ensuring heat resistance and pressure strength thanks to incorporating the reinforcing layer 4. As a result, the fluid transport tube 1 is able to achieve not only high flexibility but also high heat resistance and pressure strength.

The embodiments in accordance with the present disclosure herein is not limited to the foregoing various modes, but may be modified in various ways within the scope of the disclosure without departing from the intent thereof.

(1) In the foregoing embodiments, examples of applying the fluid transport tube according to the present disclosure to the fluid transport tube 1 having two layers, namely the inner layer 2 and the outer layer 3, and to the fluid transport tube 1 having three layers, namely the inner layer 2, the outer layer 3, and the reinforcing layer 4, have been described. However, the present disclosure is not limited to these embodiments. The fluid transport tube according to the present disclosure may also be applied to a fluid transport tube having four or more layers.

(2) In the foregoing embodiments, the fluid transport tube 1 is formed by the extrusion molding, but this production is not limited to such a way. For example, the fluid transport tube 1 may be formed by injection molding.

In the production under the injection molding, first, the inner layer material is filled into the inner layer mold of an injection molding machine, cooled and solidified within the inner layer mold, and then the mold is opened to remove the inner layer 2. Subsequently, the inner layer 2 is inserted into the core of the outer layer mold. Then, the outer layer material containing a foaming agent (i.e., heat-expandable microcapsules) is fed into the hopper, fill the outer layer mold with the outer layer material, and coat the inserted inner layer 2 with outer layer 3. During molding the outer layer 3, a method known as the short shot method may be adopted, where an amount of the outer layer material less than the cavity volume of the outer layer mold is filled, and the outer layer material is filled throughout the entire outer layer mold using the force produced by foaming (i.e., the force resulting from bubbles expanding).

(3) In the above embodiment, an example of applying the fluid transport tube described in the present disclosure to a hot water transport tube for electric vehicles has been described. Alternatively, the application of the fluid transport tube is not limited to this usage.

For example, the fluid transport tube may be applied to cooling water and hot water transport tubes in hybrid vehicles, in which driving force for running is obtained from electric motors and internal combustion engines (i.e., engines), and alternatively, plug-in hybrid vehicles that can charge batteries with power supplied from an external power source when the vehicle is stopped. In addition, the fluid transport tube may be applied to cooling water and hot water transport tubes installed in cooling circuits of electric vehicle motors and batteries.

### Others

The fluid transport tube disclosed in the present specification will now be characterized as follows:

### Item 1

There is provided a fluid transport tube comprising multiple layers (2, 3) layered on one another, wherein,
the outer layer (3), of the multiple layers, is made of a thermoplastic elastomer foam,
the inner layer (2), of the multiple layers, is made of a thermoplastic elastomer or a thermoplastic resin,
the outer layer and the inner layer closely adhere with each other, and
the thermoplastic elastomer foam has a foaming factor of 2 times or more and 5.5 times or less.

### Item 2

There is provided a fluid transport tube comprising multiple layers (2, 3) layered on one another, wherein,
the outer layer (3), of the multiple layers, is made of a thermoplastic elastomer foam,
the inner layer (2), of the multiple layers, is made of a thermoplastic elastomer or a thermoplastic resin,
a reinforcing layer (4) is arranged between the outer layer and the inner layer, the reinforcing layer adhering closely with each of the outer layer and the inner layer, and
the thermoplastic elastomer foam has a foaming factor of 2 times or more and 5.5 times or less.

### Item 3

In the fluid transport tube according to item 1 or 2, wherein the foaming factor of the thermoplastic elastomer foam is larger than 3 times and 5.5 times or less.

### Item 4

In the fluid transport tube according to any one of items 1 to 3, wherein
the outer layer is made of an olefin-based thermoplastic elastomer foam, and
the inner layer is made of an olefin-based thermoplastic elastomer or an olefin-based thermoplastic resin.

### Item 5

In the fluid transport tube according to item 1 or 2, wherein
the outer layer is made of a styrene-based thermoplastic elastomer foam,
the inner layer is made of an olefin-based thermoplastic elastomer or an olefin-based thermoplastic resin, and
the styrene-based thermoplastic elastomer foam has a foaming factor of 2 times or more and 4.8 times or less.

### Item 6

In the fluid transport tube according to any one of items 1 to 5, wherein the inner layer is made of resin of which type is different from the thermoplastic elastomer contained in the outer layer.

### Item 7

In the fluid transport tube according to any one of items 1 to 6, wherein the outer layer contains heat-expandable microcapsules.

Although the present disclosure has been described in accordance with various examples, it is understood that the present disclosure is not limited to the configurations described in the examples. The present disclosure also encompasses various variations and transformations within the scope of equivalence. In addition, various combinations and forms, as well as other combinations and forms including only one element, more or less, thereof, also fall within the scope and technical ideas of the present disclosure.

1. A fluid transport tube comprising multiple layers layered on one another, the fluid transport tube being installed in an electric vehicle in which all or part of driving force for running is obtained from an electric motor installed in the electric vehicle, wherein,
the outer layer, of the multiple layers, is made of a thermoplastic elastomer foam,
the inner layer, of the multiple layers, is made of a thermoplastic elastomer or a thermoplastic resin,
the outer layer and the inner layer closely adhere with each other on entire circumferences thereof, and
the thermoplastic elastomer foam has a foaming factor of 2 times or more and 5.5 times or less.

2. A fluid transport tube comprising multiple layers layered on one another, wherein,
the outer layer, of the multiple layers, is made of a thermoplastic elastomer foam,
the inner layer, of the multiple layers, is made of a thermoplastic elastomer or a thermoplastic resin,
a reinforcing layer is arranged between the outer layer and the inner layer, the reinforcing layer adhering closely with each of the outer layer and the inner layer on entire circumferences thereof, and
the thermoplastic elastomer foam has a foaming factor of 2 times or more and 5.5 times or less.

3. The fluid transport tube according to claim 1, wherein the foaming factor of the thermoplastic elastomer foam is larger than 3 times and 5.5 times or less.

4. The fluid transport tube according to claim 1, wherein
the outer layer is made of an olefin-based thermoplastic elastomer foam, and
the inner layer is made of an olefin-based thermoplastic elastomer or an olefin-based thermoplastic resin.

5. The fluid transport tube according to claim 1, wherein
the outer layer is made of a styrene-based thermoplastic elastomer foam,
the inner layer is made of an olefin-based thermoplastic elastomer or an olefin-based thermoplastic resin, and
the styrene-based thermoplastic elastomer foam has a foaming factor of 2 times or more and 4.8 times or less.

6. The fluid transport tube according to claim 1, wherein
the inner layer is made of resin of which type is different from the thermoplastic elastomer contained in the outer layer.

7. The fluid transport tube according to claim 1, wherein
the outer layer contains heat-expandable microcapsules.

8. The fluid transport tube according to claim 2, wherein
the reinforcing layer is made of a polyamide resin, a polyphenylene sulfide (PPS) resin, a mixture of these resins, or an adhesive

9. The fluid transport tube according to claim 2, wherein the reinforcing layer is reinforced by a reinforcing yarn that is braided.

10. The fluid transport tube according to claim 1, wherein the foaming factor of the thermoplastic elastomer foam is larger than 3 times and 5.5 times or less, with exclusion of a range where the foaming factor is 3.6 times or less.

11. A method of manufacturing a fluid transport tube according to claim 1, the method comprising a co-extrusion molding step which simultaneously extrudes a material for the inner layer and a material of the outer layer.

12. A method of manufacturing a fluid transport tube according to claim 1, the method comprising:
a step for first extruding a material for the inner layer to form an inner layer tube; and
a step for coating the outer layer onto the inner layer tube while pulling out the inner layer tube.

13. A method of manufacturing a fluid transport tube according to claim 1, the method comprising:
a step for forming the inner layer by extruding a material for the inner layer by a first extruder to from the inner layer;
a step for cooling the formed inner layer in a first water tank;
a step for coating a material for the outer layer on the inner layer by a second extruder; and
a step for cooling both the inner and outer layers in a second water tank.

14. The fluid transport tube according to claim 2, wherein the foaming factor of the thermoplastic elastomer foam is larger than 3 times and 5.5 times or less.

15. The fluid transport tube according to claim 2, wherein
the outer layer is made of an olefin-based thermoplastic elastomer foam, and
the inner layer is made of an olefin-based thermoplastic elastomer or an olefin-based thermoplastic resin.

16. The fluid transport tube according to claim 2, wherein
the outer layer is made of a styrene-based thermoplastic elastomer foam,
the inner layer is made of an olefin-based thermoplastic elastomer or an olefin-based thermoplastic resin, and
the styrene-based thermoplastic elastomer foam has a foaming factor of 2 times or more and 4.8 times or less.

17. The fluid transport tube according to claim 2, wherein
the inner layer is made of resin of which type is different from the thermoplastic elastomer contained in the outer layer.

18. The fluid transport tube according to claim 2, wherein
the outer layer contains heat-expandable microcapsules.

19. A method of manufacturing a fluid transport tube according to claim 2, the method comprising a co-extrusion molding step which simultaneously extrudes a material for the inner layer and a material of the outer layer.

20. A method of manufacturing a fluid transport tube according to claim 2, the method comprising:
a step for first extruding a material for the inner layer to form an inner layer tube; and
a step for coating the outer layer onto the inner layer tube while pulling out the inner layer tube.
